(19) United States
(12) Patent Application Publication
(10) Pub. No.: US 2005/0023456 A1
(43) Pub. Date: Feb. 3, 2005

(54) Matrix for MALDI analysis based on porous polymer monoliths

(75) Inventors: Jean M.J. Frechet, Oakland, CA (US); Frantisek Svec, Alameda, CA (US); Dominic S. Peterson, Los Alamos, NM (US); Quanzhou Luo, Richland, WA (US)

Correspondence Address: LAWRENCE BERKELEY NATIONAL LABORATORY, ONE CYCLOTRON ROAD, MAIL STOP 90B, UNIVERSITY OF CALIFORNIA, BERKELEY, CA, 94720, US

(73) Assignee: The Regents of the University of California, Oakland, CA (US)

(21) Appl. No.: 10/866,225

(22) Filed: Jun. 9, 2004

Related U.S. Application Data
(60) Provisional application No. 60/477,308, filed on Jun. 9, 2003.

(51) Int. Cl. H01J 49/00

(52) U.S. Cl. 250/288

(57) ABSTRACT

The use of porous monolithic matrix for matrix-assisted laser desorption/ionization time of flight mass spectrometry analysis on a sample suspected of containing an analyte is herein described. The porous polymer monoliths provide a matrix suitable for use in detecting and analyzing low molecular weight and small molecules. The matrices described herein also facilitate the creation of arrays of monolithic matrices for high-throughput detection and screening using MALDI-TOF mass spectrometry and exhibit a long shelf-life.

### CROSS-REFERENCE TO RELATED APPLICATIONS

This application claims the benefit of priority to U.S. Provisional Patent Application No. 60/477,308, which was filed on Jun. 9, 2003, which is hereby incorporated by reference in its entirety.

### STATEMENT OF GOVERNMENT SUPPORT

This work was supported by the U.S. Department of Energy under Contract No. DE-AC03-76SF00098. The government has certain rights in this invention.

### BACKGROUND OF THE INVENTION

1. Field of the Invention

This invention relates to a matrix based on porous polymer monoliths for the detection and identification of analytes, including small molecules and low molecular weight compounds, using Matrix Assisted Laser Desorption Ionization (MALDI) spectrometry.

2. Description of the Related Art

Matrix assisted laser desorption/ionization mass spectrometry (MALDI-MS) (Karas, M.; Hillenkamp, F. Anal. Chem. 1988,60, 2299-2301; Tanaka, K.; Waki, H.; Ido, Y.; Akita, S.; Yoshida, Y.; Yoshida, T. Rapid Comm. Mass Spectr. 1988, 2, 151-153) featuring soft ionization followed by mass determination is widely used for analysis of both organic and biological polymers. In a typical implementation, the analyzed sample is co-crystallized with a matrix, which is a compound that can absorb energy of the laser pulse (Dreisewerd, K. Chem. Revs. 2003, 103, 395-425; Zenobi, R.; Knochenmuss, R. Mass Spectrometry Reviews 1998, 17, 337-366; Stump, M. J.; Fleming, R. C.; Gong, W. H.; Jaber, A. J.; Jones, J. J.; Surger, C. W.; Wilkins, C. L. Applied Spectroscopy Reviews 2003, 37, 275-303). This energy then enables a phase transition of both matrix and sample from solid to the gas phase (Dreisewerd, K. Chem. Revs. 2003, 103, 395-425), whereby the sample is ionized. (Zenobi, R.; Knochenmuss, R. Mass Spectrometry Reviews 1998, 17, 337-366). The molecule of interest is deposited in a matrix, wherein the matrix is a composition having low molecular mass, and then irradiated with a laser pulse at a wavelength wherein the matrix absorbs the energy, but the molecule of interest is ejected from the matrix into the gas phase as a charged molecule. The charged molecule of interest travels towards a detector and its mass-to-charge (m/z) ratio is determined. One of the disadvantages with conventional MALDI is that matrices are nearly always acidic. This prevents the use of MALDI to analyze compounds that will decompose in acid.

The problem typical of MALDI-TOF spectrometry of small molecules is the interference of matrix ions with the ions of interest. Several strategies such as extraction of the analyte ions from the matrix ions (Wingerath, T.; Kirsch, D.; Spengler, B.; Stahl, W. Analytical Biochemistry 1999, 272, 232-242), and use of high molecular weight matrixes are currently used to minimize these interferences. (Ayorinde, F. O.; Hambright, P.; Porter, T. N.; Keith, Q. L. Rapid Comm. Mass Spectr. 1999, 13, 2474-2479; Jones, R. M.; Lamb, J. H.; Lim, C. K. Rapid Comm. Mass Spectr. 1995, 9, 968-969.) However, this makes the sample preparation more difficult and/or labor intensive yet enabling analyses only within a limited mass range.

Wei et. al. recently developed desorption/ionization on porous silicon (DIOS) that completely avoids the use of matrix in the mass spectrometric analysis. (Wei, J.; Buriak, J. M.; Siuzdak, G. Nature 1999, 399, 243-246). The sample is applied on the porous surface of an etched silicon wafer (Kruse, R. A.; Li, X. L.; Bohn, P. W.; Sweedler, J. V. Anal. Chem. 2001, 73, 3639-3645; Shen, Z. X.; Thomas, J. J.; Averbuj, C.; Broo, K. M.; Engelhard, M.; Crowell, J. E.; Finn, M. G.; Siuzdak, G. Anal. Chem. 2001, 73, 612-619) that enhances the generation of ions due to a combination of its large surface area, optical absorption, and thermal conductivity. However, the etched silicon surface rapidly oxidizes and therefore the plate must be used soon after its preparation. Since the interferences originating from this surface have been found very small and mostly represent compounds adsorbed from the air, reliable analysis of the small molecules can be achieved (Kruse, R. A.; Rubakhin, S. S.; Romanova, E. V.; Bohn, P. W.; Sweedler, J. V. Journal of Mass Spectrometry 2001, 36, 1317-1322; Tuomikoski, S.; Huikko, K.; Grigoras, K.; Ostman, P.; Kostiainen, R.; Baumann, M.; Abian, J.; Kotiaho, T.; Franssila, S. LAb on a Chip 2002, 2, 247-253; Tuomikoski, S.; Huikko, K.; Ostman, P.; Grigoras, K.; Baumann, M.; Kostiainen, R.; Franssila, S.; Kotiaho, T. in Micro Total Analysis Systems 2002, 503-505, Baba, Y.; Van den Berg, A., Eds.; Kluwer Academic Publishers: Dordrecht, 2002; Go, E. P.; Prenni, J. E.; Wei, J.; Jones, A.; Hall, S. C.; Witkowska, H. E.; Shen, Z.; Siuzdak, G. Anal. Chem. 2003, 75, 2504-2506; and Huikko, K.; Östman, P.; Sauber, C.; Mandel, F.; Franssila, S.; Kotiaho, T.; Kostiainen, R. Rapid Comm. Mass Spectr. 2003, 17, 1339-1343).

An improvement in signal intensity has also been achieved using typical matrixes such as 2,5-dihydroxybenzoic acid (DBH) and a-cyano-4-hydroxycinnamic acid (CHCA) covalently attached to the internal surface of porous silica beads that were then deposited as a thin layer at the target plate. Better defined porous films were prepared via sol-gel technique using a mixture of tetraethoxysilane and its reaction product with DBH (Lin, Y. S.; Chen, Y. C. Anal. Chem. 2002, 74, 5793-5798). The incorporation of DBH in the film resulted in a matrix interference-free background and enabled the analysis of low molecular weight compounds. Although useful, this approach creates a matrix that includes acidic silanol functionalities, making it is less suitable for ionization of acid labile compounds.

Perreault et al., in U.S. Pat. No. 6,265,715, use non-porous membranes as sample supports for MALDI-TOF mass spectrometry analysis of peptides and proteins as well as for the analysis of whole blood. Black et al, in U.S. Pat. No. 6,677,161, use aerogels as matrices, while others such as Hillenkamp in U.S. Pat. No. 6,723,564 use liquid matrices for mass spectrometry.

Therefore there is a need to create neutral, non-volatile matrices, which do not produce ions in the low molecular weight range interfering with the ions of interest and enable MALDI MS analysis of a wide variety of compounds without a negative effect on their composition.

### BRIEF SUMMARY OF THE INVENTION

The present invention provides a matrix, comprising a porous polymer monolithic matrix capable of holding a sample for MALDI-TOF. The matrix can further comprise a matrix support supporting the porous polymer monolithic matrix whereby the matrix support comprises metal, silicon, ceramic or polymeric material. The present invention also provides a method performing matrix-assisted laser desorption/ionization time of flight mass spectrometry analysis for detection and analysis of a sample comprising, providing a porous polymer monolithic matrix capable of holding a sample.

In one aspect, the sample comprises an analyte to be detected or analyzed by MALDI-TOF. In another embodiment, the analyte can be selected from the group consisting of peptides, proteins, synthetic polymers, oligonucleotides, oligosaccharides, lipids, acid labile compounds, inorganic and organic small molecules, drugs and explosives. In another embodiment, the analyte is an organic or inorganic small molecule having a molecular mass to charge ratio of 80-1000.

In another aspect, the porous polymer monolithic matrix is comprised of a crosslinked polyvinyl monomer, wherein the polyvinyl monomer is one or more monomers selected from the group consisting of alkylene diacrylates, alkylene diacrylamides, alkylene dimethacrylates, alkylene diacrylamides, alkylene dimethacrylamides, hydroxyalkylene diacrylates, hydroxyalkylene dimethacrylates, wherein the alkylene group in each of the aforementioned alkylene monomers consists of 1-6 carbon atoms, oligoethylene glycol diacrylates, oligoethylene glycol dimethacrylates, vinyl esters of polycarboxylic acids, divinylbenzenes, divinylnaphthalenes, pentaerythritol dimethacrylates, pentaerythritol trimethacrylates, or pentaerythritol tetramethacrylates, pentaerythritol diacrylates, pentaerythritol triacrylates, pentaerythritol tetraacrylates, trimethylopropane trimethacrylates and trimethylopropane acrylates. In one embodiment, the polyvinyl monomer is selected from group consisting of ethylene dimethacrylate and divinylbenzene.

In another aspect, the porous polymer monolithic matrix may further comprise a monovinyl monomer, wherein the monovinyl monomer is selected from the group consisting of vinylacetates, vinylpyrrolidones, vinylazlactones, acrylic acids, acrylamides, alkyl derivatives of methacrylamide, alkyl derivatives of acrylamide, alkyl acrylates, perfluorinated alkyl acrylates, perfluorinated alkyl methacrylates, hydroxyalkyl acrylates, hydroxyalkyl methacrylates, oligoethylene glycol acrylates, oligoethylene glycol methacrylates and derivatives thereof, wherein the alkyl group in each of the alkyl monomers has 1-10 carbon atoms. In one embodiment, the monovinyl monomer is selected from the group consisting of butyl methacrylate, benzyl methacrylate and styrene.

In another aspect of the invention, the porous monolithic matrix has a percent porosity of about 45 to 85%. In another aspect, the pores of said porous polymer monolithic matrix have a pore size of about 5 to about 3000 nm, about 10 nm to about 3000 nm, or about 10 to about 600 nm.

The method of the invention can further comprise the steps of: (a) applying the sample to said porous polymer monolithic matrix; (b) allowing the sample to dry; and (c) carrying out MALDI-TOF mass spectrometric analysis of the sample.

The present invention further provides a method of detecting an analyte in a sample using matrix-assisted laser desorption/ionization time of flight mass spectrometry analysis comprising: providing an array of porous polymer monolithic matrices capable of holding a plurality of sample, wherein each porous polymer monolithic matrix in the array has a different porosity, functionality or property to aid in detection of the analyte in the sample.

In one aspect, the method may further comprise (a) providing a matrix support to support the porous polymer monolithic matrix array; (b) applying the sample to said array of porous polymer monolithic matrices; (d) allowing the sample to dry; and (e) carrying out MALDI-TOF mass spectrometric analysis of the sample. In a preferred embodiment, each porous polymer monolithic matrix in the array of porous polymer monolithic matrices has a different porosity, functionality or property to aid in the detection and analysis of the analyte.

In one aspect of the present method, each of the porous polymer monolithic matrices in the array is comprised of the same or different crosslinked polyvinyl monomer or crosslinked polyvinyl and monovinyl monomers. In another aspect, each of the arrayed monolithic matrices is grafted with a functional monomer. The functional monomer can be selected from the group consisting of methyl acrylate, methyl methacrylate, butyl acrylate, butyl methacrylate, tert-butyl acrylate, tert-butyl methacrylate, 2-hydroxyethyl acrylate, 2-hydroxyethyl methacrylate, acrylic acid, methacrylic acid, glycidyl methacrylate, 4,4-dimethyl-2-vinylazlactone, ethylene diacrylate, ethylene dimethacrylate, acrylamide, N-isopropylacrylamide, potassium 3-sulfopropyl acrylate, 2-acryloamido-2-methyl-1-propanesulfonic acid, 2-acrylamidoglycolic acid, [2-(methacryloyloxy)ethyl]trimethylammonium chloride, and N-[3-(dimethylamino)propyl]methacrylamide. In another aspect, each of the arrayed monolithic matrices may have the same or different porosity.

### BRIEF DESCRIPTION OF DRAWINGS

FIG. 1 shows the mass spectrum obtained using blank monolithic matrix at a laser power of 67% (A) and CHCA matrix using a laser power of 45% (B).

FIG. 2 shows the mass spectrum from caffeine ionized from monolithic matrix using a laser power of 62 (A), 65 (B), 70 (C), and 82% (D).

FIG. 3 shows the mass spectrum of caffeine using monolithic matrix with a pore size of 70 (A), 200 (B), 960 (C), and 2130 nm (D).

FIG. 4 shows the mass spectra for nortriptyline applied to the monolithic matrix in various solvents: water (A), 10 mM ammonium acetate (B), 0.1% formic acid (C), and 0.1% trifluoroacetic acid (D).

FIG. 5 shows the mass spectra of caffeine using poly(benzyl methacrylate-co-ethylene dimethacrylate) (A) and (styrene-co-divinylbenzene) monolithic matrix (B).

FIG. 6 shows the mass spectrum of caffeine using a monolithic matrix and analyzed immediately after preparation (A), and 3 weeks after preparation (B).

FIG. 7 shows the mass spectra of small peptides analyzed using monolithic matrix: leucine enkephalin (A), and valine-tyrosine-valine (B).

FIG. 8 shows the mass spectrum of explosive Tetryl using monolithic matrix.

FIG. 9 shows the mass spectrum analysis of an acid labile compound using monolithic matrix.

### DETAILED DESCRIPTION OF THE PREFERRED EMBODIMENT

The present invention herein describes a porous polymer monolith as a matrix for use in matrix-assisted laser desorption/ionization time-of-flight (MALDI-TOF) mass spectrometry detection and analysis of small molecules. The porous surface of these monolithic matrices absorbs sufficient energy and then transfers it to the analyte to induce the desorption and ionization of the analyte thus enabling mass spectrometric analysis. The porous polymer monolithic matrices are very stable and can be stored and used long after their preparation. They can be used for the detection and analysis of a variety of compounds, such as small molecules including, but not limited to, peptides, proteins, synthetic polymers, oligonucleotides, oligosaccharides, lipids, acid labile compounds, inorganic and organic small molecules, such as drugs or explosives.

By the term “small molecules” it is meant any molecular compound having a molecular weight between 100 Da and 1000 KDa, more preferably between 100 Da and 700 KDa.

By the term “sample” it is meant a medium, i.e. composition capable of being analyzed using MALDI-TOF. It is understood that the sample may contain an analyte, that is also a composition capable of being analyzed using MALDI-TOF. Thus, the sample may be the analyte, or the analyte may be contained in the sample.

By the term “providing” it is meant that definition with which the term is normally used by those in the art, including the act of acquiring, preparing, furnishing, supplying, or making.

By the term “a matrix support supporting the porous polymer monolithic matrix” it is meant that the polymer monolithic matrix may be either attached, removeably attached, non-attached, that the polymer monolithic matrix is merely sitting on the matrix support, and the polymer mololithic matrix may be polymerized onto the support; there may be any number of intervening layers between the porous monolithic matrix and the matrix support, that one of ordinary skill in the art will recognize depending on the intended use, deposited upon.

By the term “derivatives” it is meant all forms of the named compound including forms of the compound having primary, secondary, tertiary, and quarternary amine, epoxide and zwitterionic functionalities, or substituted derivatives wherein the substituents include but are not limited to chloromethyl, alkyls with up to 18 carbon atoms, hydroxyl, t-butyloxycarbonyl, halogen, nitro, protected hydroxyls or amino groups.

By the term “alkyl” it is meant any saturated or unsaturated, branched, unbranched, or cyclic hydrocarbon, or a combination thereof, typically 1 to 20 carbons, and specifically includes methyl, ethyl, propyl, isopropyl, butyl, isobutyl, t-butyl, pentyl, cyclopentyl, isopentyl, neopentyl, hexyl, isohexyl, cyclohexyl, 3-methylpentyl, 2,2-dimethylbutyl, 2,3-dimethylbutyl, heptyl, octyl, nonyl, and decyl.

By the term “wt %” or “weight percent” it is meant the percent of specific component of composition by weight. Unless otherwise noted, all percentages herein listed are denoted to mean weight percent.

By the term “m/z” it is meant the molecular mass to charge ratio for a specific compound.

The present invention herein describes a matrix for and a method of performing matrix-assisted laser desorption/ionization time of flight mass spectrometry analysis comprising providing a porous polymer monolithic matrix capable of holding a sample. The method can further comprise the steps of (a) providing a matrix support; (b) applying the sample to the porous polymer monolithic matrix; (c) allowing the sample to dry; and (d) carrying out MALDI-TOF mass spectrometric analysis of the sample.

In the present invention, matrix supports or substrates have the structure commonly associated with filters, wafers, plates or membranes and thin films that one of ordinary skill in the art is aware of. Further the matrix supports may comprise any material depending on the desired use, including but not limited to glass, metal surfaces and materials such as steel, gold, silver, aluminum, copper, silicon, and glass, ceramic or polymeric materials such as polyethylene, polypropylene, polyamide, and polyvinylidenefluoride, etc. In one embodiment, the matrix support is a MALDI plate made of metal, glass, ceramic or the like.

In one embodiment of the invention the matrix comprising the porous polymer monolithic matrix is a solid porous polymer body containing pores, but it is not so limited. The matrix generally has a thickness of up to about 1 mm and is prepared and/or supported upon a matrix support for use with a MALDI instrument. In one embodiment, the thickness of the body of the porous polymer monolithic matrix of the present invention is in the range of 0.3 to 500 micrometers. In one embodiment, the thickness of the body of the porous polymer monolithic matrix is about 100-300 micrometers. In another embodiment, the thickness of the body of the porous polymer monolithic matrix is about 0.3 to 0.5 micrometers.

In one embodiment of the present invention porous polymer monolithic matrices are prepared by polymerizing a mixture comprising polyvinyl monomer in the presence of an initiator, and a porogen. In a preferred embodiment, the polymerization mixture is comprised of a mixture of a monovinyl monomer, polyvinyl monomer, initiator, and a porogen.

In one embodiment, the polymerization mixture may be disposed on the matrix support and polymerization is initiated thereupon so as to form the monolithic matrix, which is then washed with a suitable solvent to remove the porogen. It is further contemplated that the monolithic polymerization mixture has been prepared and polymerized first and then disposed upon the matrix support.

Examples of compositions of the monolithic matrix are disclosed for use as chromatography columns in U.S. Pat. Nos. 5,334,310; 5,453,185; and 5,929,214, the teachings of which are each hereby incorporated by reference in their entirety. In the present invention, the polymerization mixture is comprised of a polyvinyl monomer in an amount of about 10 to 60 vol %, and more preferably from about 20 to 50 vol %, about 45-85 vol % porogens and about 1 vol % initiator. In one embodiment, the polymerization mixture is comprised of about 5-50% of a monovinyl monomer, 10 to 60 vol % of a polyvinyl monomer, about 45-85 vol % porogens and about 1 vol % initiator. The ranges of each of the monomers, crosslinkers and porogens can be varied depending on the intended use. Such techniques as disclosed in U.S. Pat. Nos. 5,334,310; 5,453,185; and 5,929,214 may be used, the teachings of which are hereby incorporated by reference in their entirety.

In one embodiment useful for the present invention are polyvinyl monomers that include but are not limited to, divinylbenzene, divinylnaphthalene, divinylanthracene, divinylpyridine, alkylene diacrylates and dimethacrylates, hydroxyalkylene diacrylates and dimethacrylates, oligoethylene glycol diacrylates and dimethacrylates, vinyl esters of polycarboxylic acids, divinyl ether, divinyl benzene, pentaerythritol di-, tri-, or tetraacrylates and methacrylates, trimethylopropane trimethacrylate or triacrylate, alkylene bisacrylamides or bismethacrylamides, and mixtures of any such suitable polyvinyl monomers and derivatives thereof. The alkylene groups may generally contain about 1-6 carbon atoms, but are not so limited. In a specific embodiment, the polyvinyl monomer is ethylene dimethacrylate or divinylbenzene.

In one embodiment monovinyl monomers include but are not limited to styrene, vinylnaphthalene, vinylanthracene and their ring substituted derivatives wherein the substituents include chloromethyl, alkyls with up to 18 carbon atoms, hydroxyl, t-butyloxycarbonyl, halogen, nitro, protected hydroxyls or amino groups. Other monomers useful to form the monolithic matrix include but are not limited to, acrylamides, and methacrylamides and their derivatives substituted on the nitrogen atom with one or two C₁-C₅ alkyls, C₁-C₄ alkylaminoalkyls or dialkylaminoalkyls, C₁-C₄ methoxyaminoalkyls, C₁-C₄ dimethoxy or diethoxyaminoalkyls, C₁-C₄ methoxyalkyls, tetrahydropyranyl, and tetrahydrofurfuryl groups, N-acryloylpiperidine and N-acryloylpyrrolidone, and mixtures thereof.

In another embodiment, the monovinyl monomer may also be selected from the group consisting of acrylic and methacrylic acid esters, alkyl acrylates, alkyl methacrylates, perfluorinated alkyl acrylates, perfluorinated alkyl methacrylates, hydroxyalkyl acrylates, hydroxyalkyl methacrylates, wherein the alkyl group in each of the aforementioned alkyls consists of 1-10 carbon atoms, sulfoalkyl acrylates, sulfoalkyl methacrylates, oligoethyleneoxide acrylates, oligoethyleneoxide methacrylates, and acrylate and methacrylate derivatives including primary, secondary, tertiary, and quarternary amine, epoxide and zwitterionic functionalities, and vinylacetate, vinylpyrrolidone, vinylazlactone.

In a specific embodiment, the monovinyl monomer is selected from the group consisting of butyl methacrylate, benzyl methacrylate, and styrene.

The present invention contemplates that the porous polymer monolithic matrix can have different porous properties. The porous properties can be controlled by the total polymerization time, temperature and/or irradiation power, percentage of monomers, concentration of initiator, and composition and percentage of the porogen in the porogenic solvent. In one embodiment of the present invention the porogen used to prepare the monolithic matrix may be selected from a variety of different types of materials. For example, suitable liquid porogens include aliphatic hydrocarbons, aromatic hydrocarbons, esters, amides, alcohols, ketones, ethers, solutions of soluble polymers, and mixtures thereof. The porogen is generally present in the polymerization mixture in an amount of from about 40 to 90 vol %, more preferably from about 50 to 80 vol %. In a preferred embodiment, the porogen is 1-decanol or cyclohexanol.

In one embodiment, the composition and percentage of porogenic solvent are used to control the porous properties by changing or adjusting the percentage of the porogenic solvent mixture with a co-porogen, such as cyclohexanol, propanol, water, or butanediol. This affects both median pore size and pore volume of the resulting monoliths. A broad range of pore sizes can easily be achieved by simple adjustments in the composition of porogenic solvent.

The percent porosity is the percentage of pore volume in the total volume of the monolithic matrix. The term, “pore volume” as used herein refers to the volume of pores in 1 g of the monolith. In a preferred embodiment, the porous monolithic matrix has a percent porosity of about 45 to 85% and the median pore size of the porous polymer monolithic matrix is at least 5 to about 3000 nm. In other embodiments the median pore size is about 10 nm to about 3000 nm, or more preferably 10-600 nm.

In contrast to the pore size, the type of porogen has only a little effect on the pore volume since the fraction of pores within the final porous polymer, at the end of the polymerization, is close to the volume fraction of the porogenic solvent in the initial polymerization mixture because the porogen remains trapped in the voids of the monolithic matrix.

In the present invention polymerization can be carried out through various methods of free radical initiation mechanisms including but not limited to thermal initiation, photoinitiation, redox initiation. For polymerization triggered by UV initiation, a photolithographic-like technique using a mask can facilitate the polymerization of an array of individual monolithic matrices. For polymerization by thermal or redox initiation, the monolithic matrix polymerization mixture can be individually deposited on the substrate and a mold used to form the desired shape, and size of each monolithic matrix. In a preferred embodiment, the monolithic polymer is prepared to produce an array of individual monolithic matrices, which eases the sample detection and identification process.

In one embodiment, about 0.1-5 wt % (with respect to the monomers) of free radical or hydrogen abstracting photoinitiator can be used to create the porous polymer monolithic matrix. For example, 1 wt % (with respect to monomers) of a hydrogen abstracting initiator can be used to initiate the polymerization process.

In one embodiment, polymerization of the monolithic matrix can be achieved using hydrogen abstracting photoinitators including, but not limited to, benzophenone, 2,2-dimethoxy-2-phenylacetophenone (DMPAP), dimethoxyacetophenone, xanthone, and thioxanthone. If solubility of the chosen photoinitiator is poor, desired concentration of the initiator can be achieved by adding a surfactant that enables the homogenization of the initiator in emulsions with higher initiator concentration.

In another embodiment, whereby polymerization is carried out by thermal initiation, the thermal initiator is generally a peroxide, a hydroperoxide, peroxo- or an azocompound selected from the group consisting of benzoylperoxide, potassium peroxodisulfate, ammonium peroxodisulfate, t-butyl hydroperoxide, 2,2′-azobisiobutyronitrile (AIBN), and azobisiocyanobutyric acid and the thermally induced polymerization is performed by heating the polymerization mixture to temperatures between 30° C. and 120° C.

In another embodiment, whereby polymerization is initiated by a redox initiator, the redox initiator may be selected from the group consisting of mixtures of benzoyl peroxide-dimethylaniline, and ammonium peroxodisulfate-N,N,N′,N′-tetramethylene-1,2-ethylenediamine.

The invention further contemplates the creation of an array of polymer monoliths each having a different porosity, functionality or property to aid in the detection and analysis of unknown small molecules. Such arrays of monolithic matrices may be useful for high-throughput detection and screening of samples using MALDI-TOF mass spectrometry. For example, it may be possible to use many different monolithic compositions and chemistries including hydrophilic, ionic, zwitterionic, and reactive chemistries, to immobilize the analytes in the sample, thus creating a distinct array of monolithic matrices suitable for the detection of specific types of molecules or compounds. It is understood that the array may be as few as 2 monoliths or as many as 10,000, depending on the desired end use.

Different methods of grafting functional groups on the monolith matrix are known in the art. In one embodiment, the method as described in U.S. Pat. No. 5,929,214, is a two-step process which entails (1) vinylization of the pores followed by (2) in situ free radical polymerization of a functional vinyl monomer or mixture of functional vinyl monomers to graft them to the pores. Briefly, the pore surfaces may be functionalized by placing reactive vinyl groups thereon. A co-monomer having a functional group is added to the polymerized monolith or to the polymerization mixture and allowed to react with the vinyl monomers and polymerized in situ within the monolith. Any unreacted double bonds of the crosslinking monomer used to prepare the monolith which are on the surface of the monolith will enter into the polymerization reaction.

In a preferred embodiment, grafting of the matrix is carried out according to co-pending U.S. patent application Ser. No. 10/665,900, filed Sep. 19, 2003, which is hereby incorporated by reference. Using this method, the monolithic matrix is filled with the functional monomer or its solution and irradiated with UV light for a sufficient period of time to graft the pore surface within the monolithic matrix with this functional monomer.

In another embodiment, the method of grafting can be carried out as described in Tripp J. A., Svec F., Fréchet J. M. J., “Grafted macroporous polymer monolithic discs: A new format of scavengers for solution phase combinatorial chemistry”, J. Combi. Chem. 3, 216-223, 2001), which is hereby also incorporated by reference.

Suitable functional monomers that possess a variety of properties and functionalities can be added to the polymerization mixture or can be grafted to the surface of the polymerized monolithic matrix to modify the properties of the monolithic matrix. Suitable functional monomers may include but are in no way limited to, hydrophilic, hydrophobic, ionizable, hybridizable and reactive functionalities or precursors thereof. Examples of functional monomers include, but are not limited to, methyl acrylate, methyl methacrylate, butyl acrylate, butyl methacrylate, tert-butyl acrylate, tert-butyl methacrylate, 2-hydroxyethyl acrylate, 2-hydroxyethyl methacrylate, acrylic acid, methacrylic acid, glycidyl methacrylate, 4,4-dimethyl-2-vinylazlactone, ethylene diacrylate, ethylene dimethacrylate, acrylamide, N-isopropylacrylamide, potassium 3-sulfopropyl acrylate, 2-acryloamido-2-methyl-1-propanesulfonic acid, 2-acrylamidoglycolic acid, [2-(methacryloyloxy)ethyl]trimethylammonium chloride, and N-[3-(dimethylamino)propyl]methacrylamide.

Any combination of the above functional monomer units is intended to be within the scope of functional groups that can be present in the polymer monoliths. To obtain the cleanest spectrum analysis, it may be recommended that the MALDI-TOF MS analysis be performed on the array of monolithic matrices having different compositions and functionalities using the optimized laser power or porosity for each monolithic matrix in the array.

Once polymerization is completed, the solid monolithic matrix is washed to remove porogenic solvent and to dissolve any soluble polymer present. Suitable washing solvents include methanol, ethanol, benzene, toluene, acetone, tetrahydrofuran, and dioxan. This extraction process may be done in stages; for example, by washing with a solvent, then with water and then a solvent again, or by continuous washing with a single solvent.

Once the porous polymer monolithic matrix is prepared upon or deposited upon the matrix support, the samples to be analyzed are deposited on the monolithic matrix for analysis by MALDI-TOF mass spectrometry. In one embodiment, the sample solution is spotted or pipetted onto the monolith matrix, which is then dried and the sample analyzed. Analytes and small molecules of interest that can be detected and analyzed by this method generally have an m/z ratio of 80-1000, including analytes such as low molecular weight drugs, peptides, and explosives.

The invention contemplates the use of a variety of known sample preparation techniques for solid MALDI matrices to be used including but not limited to, dried-droplet, vacuum-drying, crushed-crystal, fast evaporation, overlayer, sandwich, spin-coating, slow-crystallization, electrospray, and “quick & dirty”. (See “MALDI-Mass Spectrometry,” Sigma-Aldrich AnalytiX, 6, 2001).

If there is a sample containing the analyte of interest, such sample can be dissolved to form a solution in a variety of solvents, including but not limited to, water, ammonium acetate, formic acid, aqueous trifluoroacetic acid or organic solvents such as tetrahydrofuran, dichloromethane, dioxane, acetonitrile, methanol, and ethanol. In a preferred embodiment, the sample should be dissolved in about 0.05-2%, preferably 0.05-0.3% aqueous trifluroacetic acid or formic acid.

The stability of the monolithic matrix was found to be excellent. Pre-formed monolithic matrices on the substrate can be stored at room temperature for extended periods of time, exposed to normal laboratory environment and still used in mass spectrometric analysis. The use of porous polymer monoliths as matrix for MALDI mass spectroscopy provides a clear advantage to current technology, which requires the analyte to be co-crystallized with the matrix before analysis. The method as described herein permits the usage of disposable and even reusable plates having on their surface pre-formed polymer monoliths as the matrix in MALDI spectrometry. Furthermore, the monolith matrices are mechanically removable from the matrix support thereby allowing the matrix support to be reused by washing the surface with a solvent such as methanol and wiping it with a lint-free cloth.

Preferably detection and analysis is performed using a linear or reflectron mode TOF instrument in positive or negative ion mode, so that the ions are accelerated through a total potential difference of about 3-30 kV in the split extraction source using either static or delayed ion extraction (DE). Time-of-flight (TOF) mass spectrometers separate ions according to their mass-to-charge ratio by measuring the time it takes generated ions to travel to a detector. The technology behind TOF mass spectrometers is described for example in U.S. Pat. Nos. 5,627,369, 5,625,184, 5,498,545, 5,160,840 and 5,045,694, the teachings of which are each specifically incorporated herein by reference.

### EXAMPLE 1

### Preparation of the Monolithic Matrix via UV Initiated Polymerization

Described herein is the preparation of hydrophobic porous polymer in a format of well-defined monoliths located on a typical stainless steel MALDI plate and its use as a matrix for surface enhanced laser desorption/ionization of small molecules.

A mixture consisting of 24% butyl methacrylate, 16% ethylene dimethacrylate, 20,1% 1-decanol, and 39.9% cyclohexanol in which 2,2-dimethoxy-2-phenylacetophenone (1% with respect to monomers) was dissolved and used for the preparation of monolithic spots via UV initiated polymerization. A small volume of the polymerization mixture was placed on the top of a stainless steel plate (Applied Biosystems, Foster City, Calif.) and covered with a 1.1 mm thick and 100 mm diameter borofloat glass wafer (Precision Glass & Optics, Santa Ana, Calif.). The mask consisted of 100 circular spots with a diameter of 3 mm. The rows and columns of the mask were labeled with numbers and letters, respectively, to facilitate finding of specific spots. This mask was taped on the top of the glass wafer. The mold was placed under the UV lamp and the contents irradiated at a distance of 30 cm. An Oriel deep UV illumination instrument (Series 8700, Stratford, Conn.) fitted with a 500 W HgXe lamp was used to initiate the polymerization. The radiation power of this lamp was adjusted to 15.0 mW/cm². Polymerization was complete in 5 min. The wafer with the mask was then carefully removed from the plate and the plate surface with attached monolithic matrices was rinsed with a stream of methanol.

Polymerization of the same mixture was simultaneously carried out in a specifically designed larger volume flat mold, which is described in Rohr, T.; Yu, C.; Davey, M. H.; Svec, F.; Fréchet, J. M. J. Electrophoresis 2001, 22, 3959-3967, to obtain sufficient quantity of monolithic material for the determination of porous properties. The pore volume and pore size were determined using an Autopore III 9400 mercury intrusion porosimeter (Micromeritics, Norcross, Ga.). Determination of nitrogen adsorption-desorption using an ASAP 2000 instrument (Micromeritics, Norcross, Ga.) was used for determination of specific surface area. The monolith prepared in this Example had a pore volume of 1.03 mL/g, a median pore size of 70 nm, a porosity of 53%, and a specific surface area of 110 m²/g.

### EXAMPLE 2

### Preparation of the Monolithic Matrices via UV Initiated Polymerization

Using method described in Example 1 and polymerization mixtures shown in Table 1, series of monolithic spots for MALDI TOF MS differing in porous properties were obtained and are labeled in columns corresponding to polymerization mixtures A through D. Table 1 below shows the polymerization mixtures, reaction conditions and porous properties of each monolithic matrix prepared from each polymerization mixtures.

TABLE 1

| Polymerization Mixture | A | B | C | D | E |
|---|---|---|---|---|---|
| ethylene dimethacrylate, wt % | 16 | 16 | 16 | 16 | 16 |
| butyl methacrylate, wt % | 24 | 24 | 24 | 24 | — |
| benzyl methacrylate, wt % | — | — | — | — | 24 |
| 1-decanol, wt % | 20.1 | 35.0 | 43.3 | 60 | 60 |
| cyclohexanol, wt % | 39.9 | 25.0 | 16.7 | — | — |
| 2,2-dimehoxy-2- | 1 | 1 | 1 | 1 | 1 |
| phenylacetophenone^{a} | | | | | |
| pore volume, mL/g | 1.03 | 1.73 | 1.79 | 1.94 | 2.37 |
| median pore diameter, nm | 70 | 200 | 960 | 2130 | 1204 |
| porosity, % | 53 | 63 | 60 | 58 | 71 |
| specific surface area, m²/g | 110 | 69 | 8 | 5 | — |

^{a}Amount of initiator with respect to monomers.

### EXAMPLE 3

### Preparation of the Monolithic Matrix via Thermal Polymerization.

Monolithic matrices were also prepared via thermally initiated polymerization from a polymerization mixture consisting of 20% styrene, 20% divinyl benzene, 43% decanol and 17% toluene using 1% AEBN (with respect to monomers) as the initiator. Polymerization was carried out using a thermal initiation assembly comprised of a MAILDI plate covered with a perforated polyethylene film that also acted as a sealing gasket. The polymerization mixture was spotted in the perforations of the film which acted as a mold to shape each monolith, on top of which was placed a heated aluminum plate which temperature was held at 80° C. Polymerization was allowed to proceed for 24 h, the mold was disassembled, and the plate surface with the attached monoliths washed with methanol. After the initial rinsing, all plates were placed in a beaker, covered with methanol, let stay overnight to extract the porogens, and dried in a vacuum oven at room temperature for several hours.

Polymerization of the same mixture was simultaneously carried out in a glass vial and the monolithic polymer used for the determination of porous properties. The pore volume of this monolithic matrix was measured at 1.93 mL/g, with the median pore diameter as 101 nm, and 67% porosity.

### EXAMPLE 4

### Mass Spectrometric Evaluation of the Monolithic Matrix

The monolithic matrix was prepared according to Example 2 using polymerization mixture C and located on a stainless steel plate. Samples for spectrometric analysis were deposited by pipette on the monolithic matrices. The mass spectra were collected using a Voyager DE Biospectrometry Workstation MALDI-TOF (Applied Biosystems, Foster City, Calif.). This instrument is equipped with a 337 nm nitrogen laser operating with a repetition rate of 3 Hz. The maximum energy output of this laser is approximately 150 μJ/cm². This power is further attenuated by a prism. The power reported in the Examples represents the attenuation level used. Each spectrum is the summation of 100 shots. An acceleration voltage of 25 kV was applied with an extraction delay of 100 ns, a grid voltage of 90%, and a guidewire of 0%.

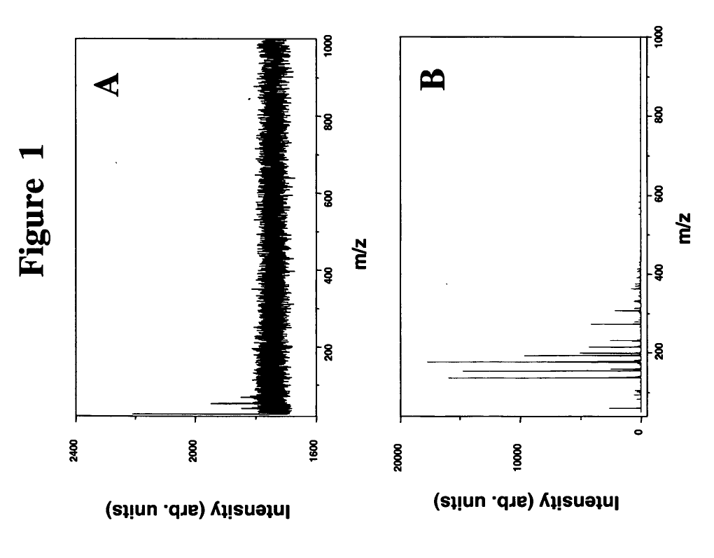

FIG. 1A shows the mass spectrum obtained by irradiating the monolithic matrix at a laser power of 67%. No interfering peaks are monitored in this spectrum.

For comparison, FIG. 1B shows the low-mass spectrum of a typical low molecular weight matrix α-cyano-4-hydroxycinnamic acid (CHCA), obtained at a laser power of only 45%. Clearly, this matrix produces a large number of peaks, particularly in the area of m/z less than 600, significantly exceeding in both their number and intensity those found in the relatively featureless spectra of the monolithic matrix obtained at any laser power. It is worth noting that the scale of peak intensity axis in FIG. 1B is two orders of magnitude larger than that in FIG. 1A.

### EXAMPLE 5

### Effect of Laser Power on Desorption/Ionization from Surface of the Monolithic Matrix

The effects of laser power on the monolithic matrix have also been studied to determine if the monolithic polymer used as a matrix might be susceptible to degradation that would lead to formation of undesirable low molecular weight products. An ISI high-resolution analytical scanning electron microscope (Topcon, Japan) was used to obtain SEM images.

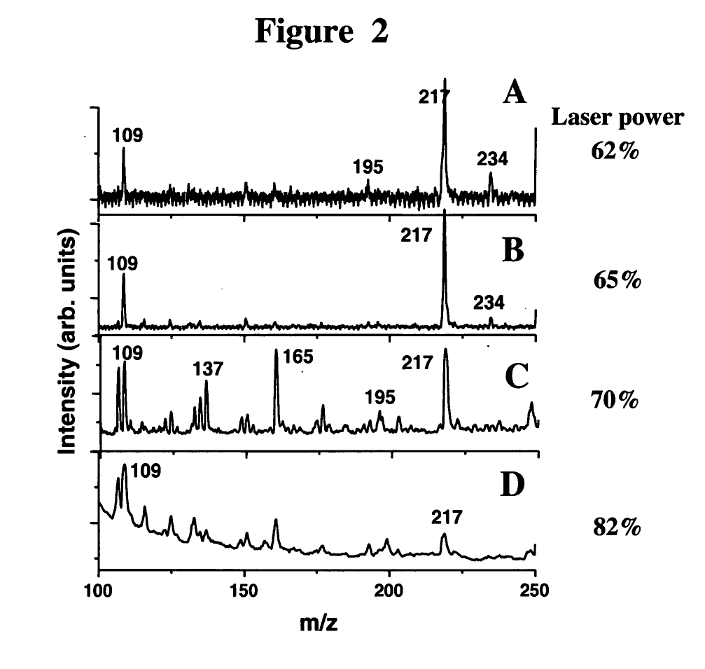

FIG. 2 shows the effect of the laser power on the analysis of caffeine applied from a 10 mmol/L aqueous ammonium acetate solution using a monolithic matrix prepared according to Example 2 using polymerization mixture B at the laser powers in the range 62-82%.

Referring now to FIG.-2A, the molecular ion of caffeine and its sodium and potassium adducts are easily detected even at the lowest laser power of 62%. A distinct peak detected at m/z of 109 results from fragmentation of the caffeine and corresponds to peaks for the masses observed previously for the decomposition products of caffeine.

At an increased laser power of 65%, the intensity of the sodium adduct of caffeine is very strong, while that for both molecular ion and potassium adduct is significantly reduced with respect to the sodium adduct (FIG. 2B). The peak of the fragment at m/z of 109 also remains very strong. At this laser power, the spectrum still remains rather clean and includes only a few small interfering peaks.

In FIG. 2C, a further increase in the laser power to 70% leads to reappearance of the molecular ion and to a decrease in the intensity for the sodium adducts relative to the background. In addition, more interfering peaks appear, which are likely due to both the fragmentation of the analyte and decomposition of the monolithic matrix. At the ultimate laser power of 80% (FIG. 2D) the S/N ratio for the ions of interest is much lower, which makes the identification of these peaks more difficult. In addition, the background is very intense and includes many contaminant peaks.

These results indicate that an optimized magnitude of the laser power helps to obtain an intense signal while suppressing the interfering fragmentation and decomposition processes.

### EXAMPLE 6

### Effect of Pore Size on Desorption/Ionization from Surface of the Monolithic Matrix

Monolithic matrices located on a stainless steel plate were prepared according to Example 2 using polymerization mixtures A, B, C and D.

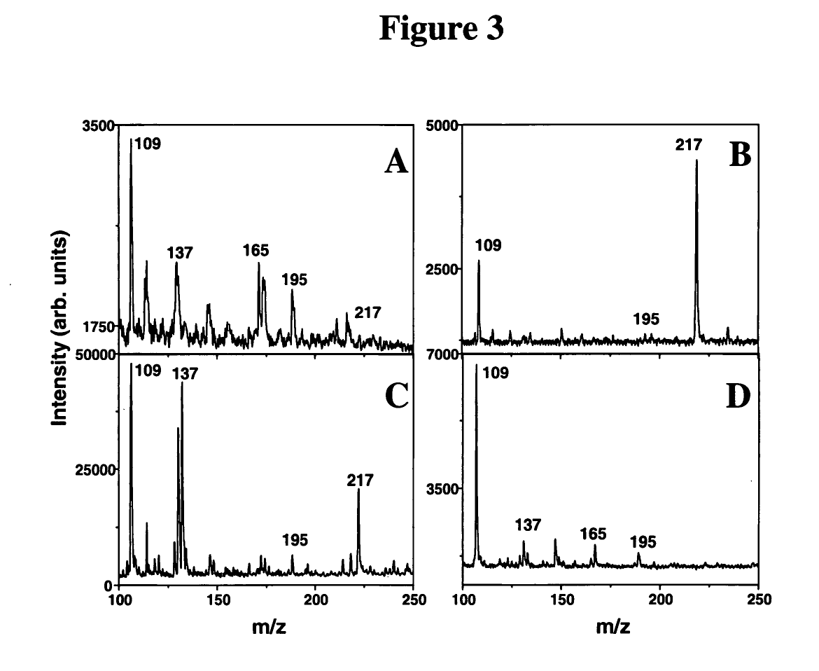

FIGS. 3A-3D shows the mass spectra of caffeine obtained using the respective monolithic matrices. Although the responses to the molecular ion, the fragment, and the sodium adduct are identifiable in the spectrum obtained using monolith A, the S/N ratio is low. A significant increase in the intensity of the sodium adduct peak is observed for monolithic matrices B and C. However, ionization from the latter is accompanied by an increase in the number of additional peaks. In contrast, the signal intensity in mass spectra obtained using monolithic matrix D with the largest pore size is much lower, while the intensity for the interfering peaks remains very high. This indicates that pore size appears to have an effect on efficient energy transfer from the laser light to the analyzed compounds.

### EXAMPLE 7

### Effect of Solvent Preparation on Desorption/Ionization from Surface of the Monolithic Matrix

Another variable that affects the mass spectrum of the analyzed compound is the solvent from which this compound is deposited since it affects the wetting of the surface (Kruse, R. A.; Li, X. L.; Bohn, P. W.; Sweedler, J. V. Anal. Chem. 2001, 73, 3639-3645). To determine the effect of solvent preparation, monolithic matrices located on a stainless steel plate were prepared according to Example 2 using polymerization mixture E.

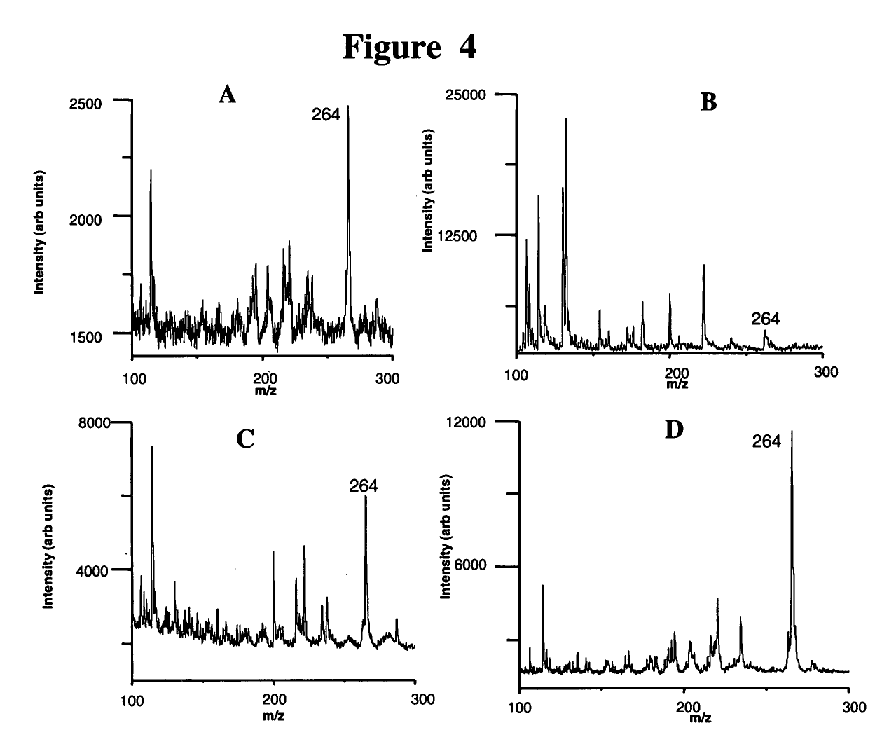

FIG. 4 shows the spectrum response obtained for nortriptyline (M+H=264) analyzed on the monolithic matrix after the analyte was deposited on the matrix. The analyte was prepared in 35 pmol solutions of water (FIG. 4A), 10 mM ammonium acetate (FIG. 4B), 0.1% formic acid (FIG.4C), and 0.1% TFA (FIG. 4D). These analyses used a laser power of 70%.

The spectra shown in FIG. 4 demonstrate that the character of the solution exerts an effect on the desorption and ionization as visualized in the mass spectra. The highest response and a rather clean spectrum are monitored for the sample prepared in the 0.1% TFA solution in FIG. 4d. In addition to the response of nortriptyline, the solution used for the preparation of the samples also appears to affect the extent of the observed fragmentation.

### EXAMPLE 8

### Effect of Chemical Composition of the Monolithic Matrix on Spectral Analysis

Monolithic matrices were prepared to observe the effect of different chemical compositions on spectral analysis of the monolithic matrices of the present invention, such as the incorporation of aromatic compounds. Therefore, monolithic matrices were prepared from polymerization mixtures comprised of monomers that include this functionality such as benzyl methacrylate, styrene, and divinyl benzene. These monolithic matrices were analyzed to determine the amount and type of background noise produced.

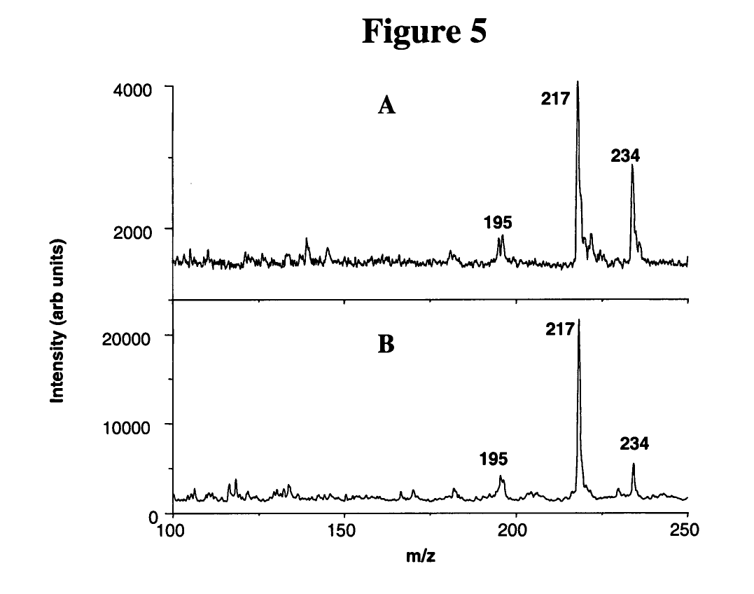

First monolithic matrix was prepared according to Example 2, using UV irradiation of polymerization mixture E, comprised of BenzMA/EDMA. FIG. 5A shows the spectrum of caffeine using this matrix.

A second monolithic matrix was prepared according Example 3 using thermal initation. FIG. 5B shows the spectrum of caffeine using monolithic F analyzed at a laser power of 60%. This spectra shows more complex noise than that observed for the methacrylate monoliths, although most of the noise is below 200 m/z and there is no noise observed above 300 m/z.

### EXAMPLE 8

### Shelf-Life and Stability of the Monolithic Matrix

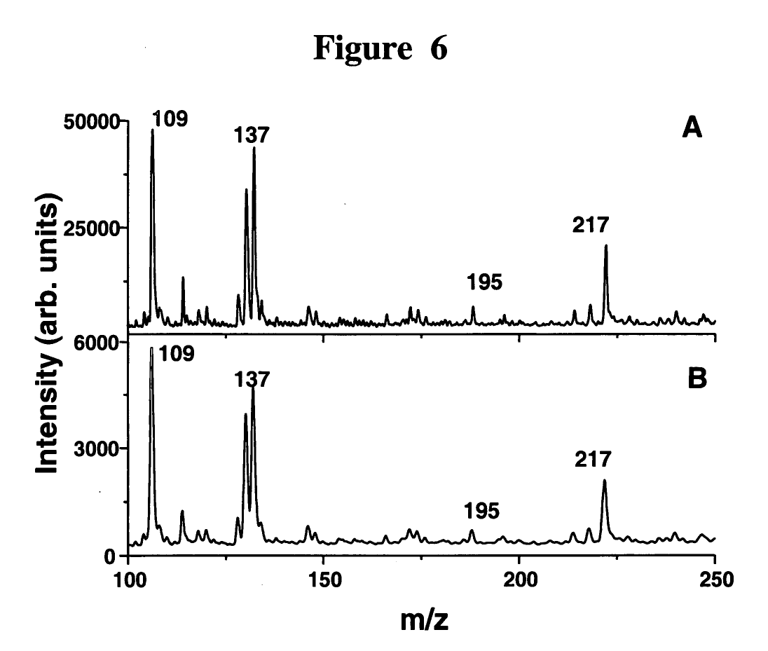

The monolithic matrices used in this Example did not contain any functionalities at their surface that might interact with oxygen, moisture, or other compounds adsorbed from the air and degrade the performance. The monolithic matrices located on a stainless steel plate were prepared according to Example 2 using polymerization mixture C and used for desorption/ionization of caffeine. FIG. 6 compares the mass spectrum of caffeine using monolithic matrices prepared and used immediately (FIG. 6A) against the spectrum of caffeine spotted on monolithic matrices exposed to the normal laboratory environment for three weeks (FIG. 6B). The same stainless steel plate was used for both the new and 3-week old monolithic matrices. Comparing FIG. 6A and FIG. 6B, the spectra are virtually identical. This demonstrates that the monolithic matrix does not change its properties after an extended period of time even without taking any specific precautions to avoid its contact with the environment.

### EXAMPLE 9

### Mass Spectrometry of Peptides

MALDI-TOF spectrometry is widely used for protein identification. However, protein mapping requires determining the peptide sequence and identification of their molecular masses. This typically involves tryptic digestion of the protein followed by MS detection of the resulting peptides. Classical MALDI is less suitable for the identification of the small peptides with m/z of less than about 700 (Cohen, L. H.; Gusev, A. I. Analytical and Bioanalytical Chemistry 2002,373,571-586).

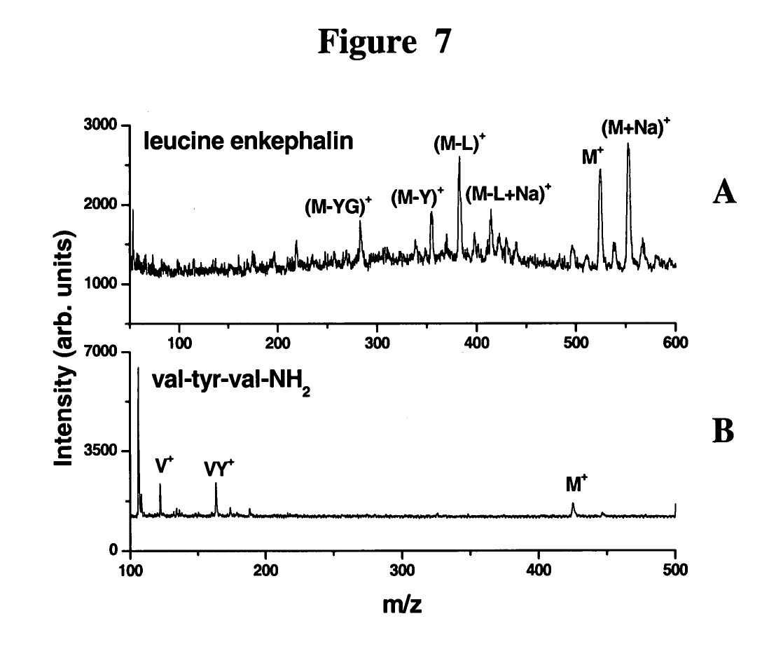

Monolithic matrices located on a stainless steel plate were prepared according to Example 2 using polymerization mixture B and used for desorption/ionization of peptides. FIG. 7 illustrates the ability of the monolithic matrix to promote ionization of peptides on mass spectra of pentapeptide leucine enkephalin (Tyr-Gly-Gly-Phe-Leu-NH₂; mol. mass 554.6) and a tripeptide (Val-Tyr-Val-NH₂; mol. mass 379).

Upper panel of FIG. 7 shows spectrum of leucine enkephalin spotted from the solution prepared in 0.1 % TFA using a laser power of 68%. Bottom panel of FIG. 7 shows mass spectrum of the tripeptide valine-tyrosine-valine spotted from the solution prepared in 10 mM ammonium acetate and analyzed using a laser power of 71%. Molecular ions, adducts and defined fragments are clearly detected in both spectrum showing that the monolithic matrix can be used for protein identification.

### EXAMPLE 10

### Mass Spectrometry of Explosives

Trace analysis of explosives, that are typical small molecules, is important for both environmental and forensic applications. Currently, the most frequent ionization methods used in the mass analysis of explosives are electrospray and atmospheric pressure chemical ionization. Since plates facilitate archiving the samples, use of soft ionization followed by TOF mass spectrometry for the detection of explosives is highly desirable.

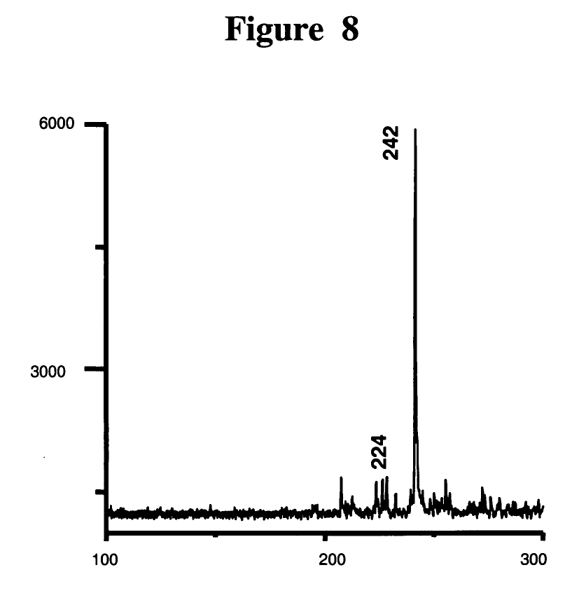

The monolithic matrix located on a stainless steel plate was prepared according to Example 2 using polymerization mixture B and used for desorption/ionization of an explosive. Tetryl (Fluka, Sigma-Aldrich, St. Louis, Mo.) was prepared in 10 mM ammonium acetate. FIG. 8 shows the mass spectra of tetryl obtained via desorption/ionization from the monolithic matrix and analyzed at 34% laser power in the negative ion mode. The spectrum for Tetryl showed very good response with two identifiable peaks showing characteristic masses including 242 and 224.

### EXAMPLE 11

### Analysis of Acid Labile Compound

The monolithic matrix located on a stainless steel plate was prepared according to Example 2 using polymerization mixture B for desorptio and ionization of an acid labile compound, N,N′-bistrifluoroacetyl-di-(2-aminoethoxy)-[4-(1,4,7,10-tetraoxaundecyl)phenyl]methane.

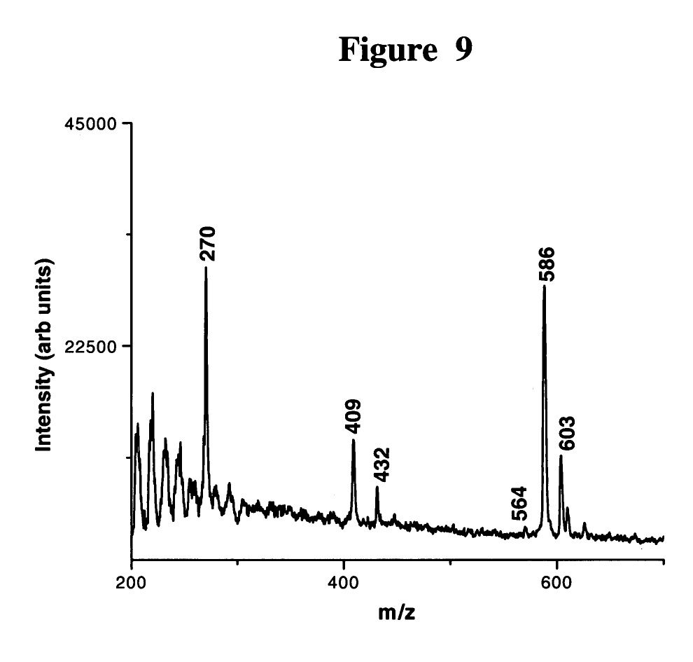

FIG. 9 shows the mass spectrum of this acid labile compound that cannot be analyzed in MALDI TOF MS with typical matrices because their acidity catalyzes its decomposition. Since the monolithic matrix of this Example is neutral, the undesired decomposition does not occur. Molecular ions, adducts and defined fragments are clearly detected. The spectrum show the molecular ion and sodium and potassium adducts very clearly detected at m/z 564, 587 and 604 respectively. This data agrees with fast atom bombardment MS data previously determined (Murthy, N.; Xu, M.; Schuck, S.; Kunisawa, J.; Shastri, N.; Fréchet, J. M. J. Proceedings of the National Academy of Sciences 2003,100, 4995-5000). The spectrum also displays a peak at m/z 409 and 270, which are apparently fragmentation peaks. This data clearly shows that this method can be used to analyze compounds with which it would be impossible using conventional MALDI.

The present examples, methods, procedures, treatments, specific compounds and molecules are meant to exemplify and illustrate the invention and should in no way be seen as limiting the scope of the invention. Any patents or publications mentioned in this specification are indicative of levels of those skilled in the art to which the patent pertains and are hereby incorporated by reference to the same extent as if each was specifically and individually incorporated by reference.

1. A method of performing matrix-assisted laser desorption/ionization time of flight mass spectrometry analysis, comprising:
providing a porous polymer monolithic matrix capable of holding a sample.

2. The method according to claim 1, wherein:
the sample comprises an analyte.

3. The method according to claim 2, wherein:
said analyte is selected from the group consisting of peptides, proteins, synthetic polymers, oligonucleotides, oligosaccharides, lipids, acid labile compounds, inorganic and organic small molecules, drugs and explosives.

4. The method according to claim 2, wherein:
said analyte is an organic or inorganic small molecule having a molecular mass to charge ratio of 80-1000.

5. The method according to claim 1, further comprising:
a matrix support supporting the porous polymer monolithic matrix.

6. The method according to claim 5, wherein:
said matrix support comprises metal, silicon, ceramic or a polymeric material.

7. The method according to claim 1, wherein:
the porous polymer monolithic matrix comprises a crosslinked polyvinyl polymer.

8. The method according to claim 7, wherein:
said polyvinyl polymer comprises one or more monomers selected from the group consisting of alkylene diacrylates, alkylene diacrylamides, alkylene dimethacrylates, alkylene diacrylamides, alkylene dimethacrylamides, hydroxyalkylene diacrylates, hydroxyalkylene dimethacrylates, wherein the alkylene group in each of the aforementioned alkylene monomers consists of 1-6 carbon atoms, oligoethylene glycol diacrylates, oligoethylene glycol dimethacrylates, vinyl esters of polycarboxylic acids, divinylbenzenes, divinylnaphthalenes, pentaerythritol dimethacrylates, pentaerythritol trimethacrylates, or pentaerythritol tetramethacrylates, pentaerythritol diacrylates, pentaerythritol triacrylates, pentaerythritol tetraacrylates, trimethylopropane trimethacrylates and trimethylopropane acrylates.

9. The method according to claim 8, wherein:
said polyvinyl monomer comprises ethylene dimethacrylate or divinylbenzene.

10. The method according to claim 1, wherein:
said porous polymer monolithic matrix further comprises a monovinyl monomer.

11. The method according to claim 10, wherein:
said monovinyl monomer is selected from the group consisting of vinylacetates, vinylpyrrolidones, vinylazlactones, acrylic acids, acrylamides, alkyl derivatives of methacrylamide, alkyl derivatives of acrylamide, alkyl acrylates, perfluorinated alkyl acrylates, perfluorinated alkyl methacrylates, hydroxyalkyl acrylates, hydroxyalkyl methacrylates, oligoethylene glycol acrylates, oligoethylene glycol methacrylates and derivatives thereof, wherein the alkyl group in each of the alkyl monomers has 1-10 carbon atoms.

12. The method according to claim 11 wherein:
said monovinyl monomer is selected from the group consisting of butyl methacrylate, benzyl methacrylate and styrene.

13. The method according to claim 1, wherein:
said porous monolithic matrix has a percent porosity of about 45 to 85%.

14. The method according to claim 1, wherein:
the pores of said porous polymer monolithic matrix have a pore size of about 5 to about 3000 nm.

15. The method according to claim 14, wherein:
the pores of said porous polymer monolithic matrix have a pore size of about 10 nm to about 3000 nm.

16. The method according to claim 14, wherein:
the pores of said porous polymer monolithic matrix have a pore size of about 10 to about 600 nm.

17. The method according to claim 1, further comprising:
(a) applying the sample to said porous polymer monolithic matrix;
(b) allowing the sample to dry; and
(c) carrying out MALDI-TOF mass spectrometric analysis of the sample.

18. A method of performing matrix-assisted laser desorption/ionization time of flight mass spectrometry analysis, comprising:
providing an array of porous polymer monolithic matrices capable of holding a plurality of samples.

19. The method according to claim 18, wherein:
each of said samples comprises an analyte.

20. The method according to claim 19, wherein:
said analyte is selected from the group consisting of peptides, proteins, synthetic polymers, oligonucleotides, oligosaccharides, lipids, acid labile compounds, inorganic and organic small molecules, drugs and explosives.

21. The method according to claim 19 wherein:
said analyte is a small molecule having a molecular mass to charge ratio of 80-1000.

22. The method according to claim 18, further comprising:
a matrix support supporting the porous polymer monolithic matrix.

23. The method according to claim 22, wherein:
said matrix support comprises metal, silicon, ceramic or polymeric material.

24. The method according to claim 18 wherein:
the porous polymer monolithic matrix is comprised of a crosslinked polyvinyl polymer.

25. The method according to claim 24 wherein:
each of the porous polymer monolithic matrices in the array is comprised of the same or different crosslinked polyvinyl polymer.

26. The method according to claim 25 wherein:
said polyvinyl polymer comprises of one or more monomers selected from the group consisting of alkylene diacrylates, alkylene diacrylamides, alkylene dimethacrylates, alkylene diacrylamides, alkylene dimethacrylamides, hydroxyalkylene diacrylates, hydroxyalkylene dimethacrylates, wherein the alkylene group in each of the aforementioned alkylene monomers consists of 1-6 carbon atoms, oligoethylene glycol diacrylates, oligoethylene glycol dimethacrylates, vinyl esters of polycarboxylic acids, divinylbenzenes, divinylnaphthalenes, pentaerythritol dimethacrylates, pentaerythritol trimethacrylates, or pentaerythritol tetramethacrylates, pentaerythritol diacrylates, pentaerythritol triacrylates, pentaerythritol tetraacrylates, trimethylopropane trimethacrylates and trimethylopropane acrylates.

27. The method according to claim 25 wherein:
said polyvinyl polymer is selected from group consisting of ethylene dimethacrylate and divinylbenzene.

28. The method according to claim 24 wherein:
said porous polymer monolithic matrix further comprises a monovinyl monomer.

29. The method according to claim 28 wherein:
said monovinyl monomer is selected from the group consisting of vinylacetates, vinylpyrrolidones, vinylazlactones, acrylic acids, acrylamides, alkyl derivatives of methacrylamide, alkyl derivatives of acrylamide, alkyl acrylates, perfluorinated alkyl acrylates, perfluorinated alkyl methacrylates, hydroxyalkyl acrylates, hydroxyalkyl methacrylates, oligoethylene glycol acrylates, oligoethylene glycol methacrylates and derivatives thereof, wherein the alkyl group in each of the alkyl monomers has 1-10 carbon atoms.

30. The method according to claim 29 wherein:
said monovinyl monomer is selected from group consisting of butyl methacrylate, benzyl methacrylate and styrene.

31. The method according to claim 24 wherein:
said porous polymer monolithic matrix further comprising a grafted functional monomer.

32. The method according to claim 31 wherein:
said functional monomer is selected from the group consisting of methyl acrylate, methyl methacrylate, butyl acrylate, butyl methacrylate, tert-butyl acrylate, tert-butyl methacrylate, 2-hydroxyethyl acrylate, 2-hydroxyethyl methacrylate, acrylic acid, methacrylic acid, glycidyl methacrylate, 4,4-dimethyl-2-vinylazlactone, ethylene diacrylate, ethylene dimethacrylate, acrylamide, N-isopropylacrylamide, potassium 3-sulfopropyl acrylate, 2-acryloamido-2-methyl-1-propanesulfonic acid, 2-acrylamidoglycolic acid, [2-(methacryloyloxy)ethyl]trimethylammonium chloride, and N-[3-(dimethylamino)propyl]methacrylamide.

33. The method according to claim 18, wherein:
each of the porous polymer monolithic matrices in the array having the same or different percent porosity.

34. The method according to claim 33 wherein:
each porous monolithic matrix having a percent porosity of about 45 to 85%.

35. The method according to claim 33 wherein:
the pores of said porous polymer monolithic matrix have a pore size of about 5 to about 3000 nm.

36. The method according to claim 33 wherein:
the pores of said porous polymer monolithic matrix have a pore size of about 10 nm to about 3000 nm.

37. The method according to claim 33 wherein:
the pores of said porous polymer monolithic matrix have a pore size of about 10 to about 600 nm.

38. The method according to claim 18 further comprising the steps of:
(a) applying the samples to said array of porous polymer monolithic matrices;
(b) allowing the samples to dry; and
(c) carrying out MALDI-TOF mass spectrometric analysis of the samples.

39. A matrix capable of holding a sample for analysis by MALDI-TOF, comprising: a porous polymer monolithic matrix and a sample deposited thereupon.

40. The matrix of claim 39, wherein:
said sample comprises an analyte.

41. The matrix of claim 40, wherein:
said analyte is selected from the group consisting of peptides, proteins, synthetic polymers, oligonucleotides, oligosaccharides, lipids, acid labile compounds, inorganic and organic small molecules, drugs and explosives.

42. The matrix of claim 40, wherein:
said analyte is an organic or inorganic small molecule having a molecular mass to charge ratio of 80-1000.

43. The matrix of claim 39, further comprising:
a matrix support supporting said porous polymer monolithic matrix.

44. The matrix of claim 43, wherein:
said matrix support comprises metal, silicon, ceramic or polymeric material.

45. The matrix of claim 39, wherein:
the porous polymer monolithic matrix is comprised of a crosslinked polyvinyl polymer.

46. The matrix of claim 45 wherein:
said polyvinyl polymer comprises one or more monomers selected from the group consisting of alkylene diacrylates, alkylene diacrylamides, alkylene dimethacrylates, alkylene diacrylamides, alkylene dimethacrylamides, hydroxyalkylene diacrylates, hydroxyalkylene dimethacrylates, wherein the alkylene group in each of the aforementioned alkylene monomers consists of 1-6 carbon atoms, oligoethylene glycol diacrylates, oligoethylene glycol dimethacrylates, vinyl esters of polycarboxylic acids, divinylbenzenes, divinylnaphthalenes, pentaerythritol dimethacrylates, pentaerythritol trimethacrylates, or pentaerythritol tetramethacrylates, pentaerythritol diacrylates, pentaerythritol triacrylates, pentaerythritol tetraacrylates, trimethylopropane trimethacrylates and trimethylopropane acrylates.

47. The matrix of claim 46 wherein:
said polyvinyl monomer is selected from group consisting of ethylene dimethacrylate and divinylbenzene.

48. The matrix according to claim 39 wherein:
said porous polymer monolithic matrix further comprises a monovinyl monomer.

49. The matrix of claim 48 wherein:
said monovinyl monomer is selected from the group consisting of vinylacetates, vinylpyrrolidones, vinylazlactones, acrylic acids, acrylamides, alkyl derivatives of methacrylamide, alkyl derivatives of acrylamide, alkyl acrylates, perfluorinated alkyl acrylates, perfluorinated alkyl methacrylates, hydroxyalkyl acrylates, hydroxyalkyl methacrylates, oligoethylene glycol acrylates, oligoethylene glycol methacrylates and derivatives thereof, wherein the alkyl group in each of the alkyl monomers has 1-10 carbon atoms.

50. The matrix of claim 49 wherein:
said monovinyl monomer is selected from group consisting of butyl methacrylate, benzyl methacrylate and styrene.

51. The matrix of claim 39 wherein:
said porous polymer monolithic matrix further comprising a grafted functional monomer.

52. The matrix of claim 51 wherein:
said functional monomer is selected from the group consisting of methyl acrylate, methyl methacrylate, butyl acrylate, butyl methacrylate, tert-butyl acrylate, tert-butyl methacrylate, 2-hydroxyethyl acrylate, 2-hydroxyethyl methacrylate, acrylic acid, methacrylic acid, glycidyl methacrylate, 4,4-dimethyl-2-vinylazlactone, ethylene diacrylate, ethylene dimethacrylate, acrylamide, N-isopropylacrylamide, potassium 3-sulfopropyl acrylate, 2-acryloamido-2-methyl-1-propanesulfonic acid, 2-acrylamidoglycolic acid, [2-(methacryloyloxy)ethyl]trimethylammonium chloride, and N-[3-(dimethylamino)propyl]methacrylamide.

53. The matrix of claim 39 wherein:
said porous monolithic matrix has a percent porosity of about 45 to 85%.

54. The matrix according to claim 39 wherein:
the pores of said porous polymer monolithic matrix have a pore size of about 5 to about 3000 nm.

55. The matrix according to claim 54 wherein:
the pores of said porous polymer monolithic matrix have a pore size of about 10 nm to about 3000 nm.

56. The matrix according to claim 55 wherein:
the pores of said porous polymer monolithic matrix have a pore size of about 10 to about 600 nm.

57. The matrix according to claim 39 wherein:
the sample is allowed to dry before MALDI-TOF mass spectrometric analysis of the sample is performed.
